(19) United States
(12) Patent Application Publication
(10) Pub. No.: US 2023/0105364 A1
(43) Pub. Date: Apr. 6, 2023

(54) LIGHT DETECTION AND RANGING (LiDAR) ON-FIELD CHANNEL REDUNDANCY

(71) Applicant: Renesas Electronics America Inc., Milpitas, CA (US)

(72) Inventor: Alberto Troia, Munich (DE)

(73) Assignee: Renesas Electronics America Inc., Milpitas, CA (US)

(21) Appl. No.: 17/495,153

(22) Filed: Oct. 6, 2021

(51) Int. Cl. G01S 7/497; G01S 7/4863

(52) U.S. Cl. CPC G01S 7/497; G01S 7/4863

(57) ABSTRACT

A method and a system may include a light detection and ranging (LiDAR) system having one or more redundant channels, as well as software executed by a microcontroller, or controller, to use the redundant channels in response to and instead of detected, failed channels. For example, inputs to a failed channel from photodiodes may be replaced from the failed channel to a redundant channel. The substitution of the redundant channel for the failed channel may occur seamlessly, allowing for uninterrupted operation of the LiDAR system.

### TECHNICAL FIELD

The present disclosure relates generally to circuitry and firmware used to measure distances to remote targets, and more particularly to light detection and ranging (LiDAR).

### BACKGROUND

Unless otherwise indicated herein, the materials described in this section are not prior art to the claims in this application and are not admitted to be prior art by inclusion in this section.

Light detection and ranging (LiDAR) is a technology that can be used to measure distances to remote targets. Typically, a LiDAR system includes a light source (e.g., an emitter) and a detector (e.g., sensor). The light source can be, for example, a laser which emits light having a particular operating wavelength. The operating wavelength of a LiDAR system may lie, for example, in the infrared, visible, or ultraviolet portions of the electromagnetic spectrum. The light source emits light toward a target which then scatters the light. Some of the scattered light is received back at the detector. The system determines the distance to the target based on one or more characteristics associated with the returned light. For example, the system may determine the distance to the target based on the time of flight of a returned light pulse.

LiDAR can scan an entire environment very quickly. One way that LiDAR does this is by using a very high sampling rate on the individual emitters/receivers. Each one may emit tens or hundreds of thousands of laser pulses every second. As such, more than 100,000 laser pulses can complete a round trip from the emitter on the LiDAR unit, out to the object being measured, and back to the receiver on the LiDAR unit, near the emitter in less than a second. Some systems have 64 or more of these emitter/receiver pairs, or channels. In one example, an implementation may include four photodiodes that comprise are part of one channel. Different implementations may be based on power dissipation, and die size, among other factors. Multiple channels can enable the system to generate more than a million data points per second.

The channels may use different wavelengths. The channels may further comprise separate lasers, and while they are closely aligned, they each conventionally follow a different path, have different locations for the returns, and may have different numbers of returns for the same pulse. An internal or external failure of a channel can prevent the system from forming a complete and accurate depiction of an environment. For example, a defect in silicon containing trans-impedance amplifiers (TIA) can render an entire system unusable. Repairing a LiDAR typically entails costly equipment and lengthy downtimes.

### SUMMARY

In some examples, a method of operating a light detection and ranging (LiDAR) includes detecting a failure in a first channel of a plurality of channels of a LiDAR, and storing redundant data associated with the operation of the first channel. In response to detecting the failure, the method may include switching out the operation of the first (i.e., failed) channel for operation of a second channel of the plurality of channels using the stored redundant data.

According to a particular embodiment, an apparatus includes a first channel of a plurality of channels of a LiDAR, in addition to a second channel of the plurality of channels. The apparatus further includes a memory storing redundant data associated with the operation of the first channel, as well as a processor configured to, in response to detecting the failure, switching out the operation of the first channel for operation of a second channel of the plurality of channels using the stored redundant data.

According to another particular embodiment, a non-transitory computer-readable medium comprises instruction that, in response to execution of the instructions by a processor, cause the processor to perform the following operations: detect a failure in a first channel of a plurality of channels of a LiDAR; store redundant data associated with the operation of the first channel; and in response to detecting the failure, switch out the operation of the first channel for operation of a second channel of the plurality of channels using the stored redundant data.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a schematic diagram of a system that includes illustrates an example light detection and ranging (LiDAR) system;

FIG. 2 illustrates an example scan pattern produced by a LiDAR system, such as the system of FIG. 1;

FIG. 3 is block diagram showing a LiDAR system having a plurality of channels, including a redundant channel, as well as an MCU with registers and a nonvolatile memory that may be used to swap out operation of a failed channel for that of the redundant channel;

FIG. 4 is a block diagram of a controller, similar to the controller of FIG. 3, having software modules configured to employ redundant channels;

FIG. 5 is a block diagram of a register, such as the register shown in FIG. 3, for use in seamlessly switching operation from a failed channel to a redundant channel;

FIG. 6 is a flowchart of an embodiment of a method having illustrative steps for operating a LiDAR using a redundant channel and a nonvolatile memory that stores redundant data;

FIG. 7 is a flowchart of having illustrative steps for operating a LiDAR using a redundant channel after performing a comparison of streamed data verses archived data; and

FIG. 8 is a block diagram of an example computing device that may optionally be utilized to perform one or more aspects of techniques described herein.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

An embodiment of the system may comprise a LiDAR system having one or more redundant channels, as well as software executed by a microcontroller (MCU), or controller, to use the redundant channels in response to and instead of detected, failed channels. For example, inputs to a failed channel from photodiodes may be redirected from the failed channel to a redundant channel. The substitution of the redundant channel for the failed channel may occur seamlessly, allowing for uninterrupted operation of the LiDAR system.

A failure of a channel may occur in response to particles hitting the LiDAR system, marginalities, aging, and radiation, among other circumstances. A failure can permanently disable a channel and shut down an entire LiDAR system. An embodiment of the system may address these issues by adding one or more channels (i.e., elaboration channels) to be used for redundancy. An internal register may be used to manage the redundancy. A power on/reset flow may enable the redundant resource and disable the defective ones.

According to a particular embodiment, each register may include read/write properties. The register may also include addresses of a defective channels. Each register may additionally include fields that include addresses of redundant channels. A field of one bit for each register (or redundant resource/channel) may include data to enable or disable the redundant resource.

Examples of the system may improve the reliability of components by addressing defects early. For instance, alarms may be provided instantaneously to an autonomous vehicle about the availability of a redundant resource. The switching out of channels may avoid system shutdowns and an urgency to replace defective resources.

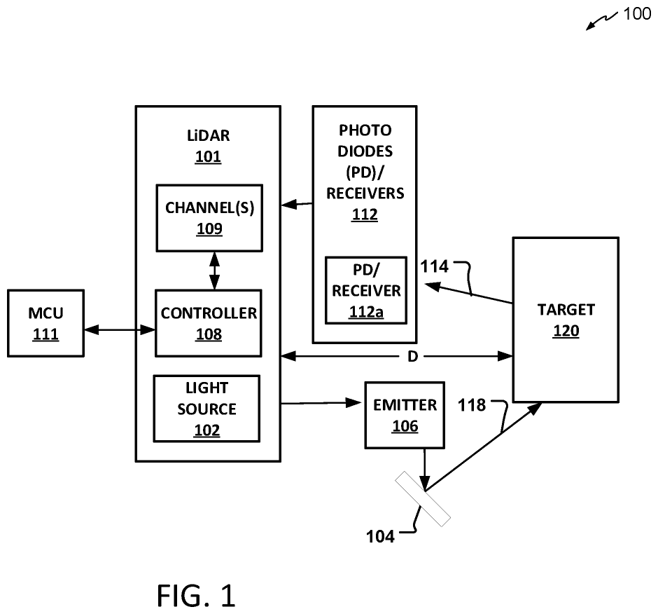

FIG. 1 illustrates a channel of a light detection and ranging (LiDAR) system 100. In particular certain applications, a LiDAR system 100 may be referred to as a laser ranging system, a laser radar system, a LiDAR system, or a laser detection and ranging (LADAR or ladar) system. As shown in FIG. 1, an illustrative LiDAR system 100 may include a light source 102, a mirror 104, an emitter 106, a receivers 112 and 112a (e.g., photo diodes), a controller 108, a channel 109, and an MCU 111. The MCU 111 may be in communication with a vehicle bus 113. The light source 102 may be, for example, a laser which emits light having a particular operating wavelength in the infrared, visible, or ultraviolet portions of the electromagnetic spectrum. As an example, the light source 102 may include a laser with an operating wavelength between approximately 1.2 micrometers and 1.7 micrometers. The light source 102 emits an emitter beam 118 that may be continuous-wave, pulsed, or modulated in any suitable manner for a given application. The emitter beam 118 is directed downrange toward a remote target 120. As an example, the remote target 120 may be located a distance D of approximately 1 foot to 1 mile from a LiDAR device 101.

Once the emitter beam 118 reaches the downrange target 120, the target 120 may scatter or reflect at least a portion of light from the emitter beam 118, and some of the scattered or reflected light may return toward the LiDAR system 100. In the example of FIG. 1, the scattered or reflected light is represented by reflected beam 114. In particular embodiments, a relatively small fraction of the light from emitter beam 118 may return to the LiDAR system 100 as reflected beam 114. As an example, if a pulse of emitter beam 118 has a pulse energy of 1 microjoule, then the pulse energy of a corresponding pulse of reflected beam 114 may have a pulse energy of approximately 10 nanojoules (nJ). In particular embodiments, emitter beam 118 may be referred to as a laser beam, light beam, optical beam, emitted beam, or beam. In particular embodiments, reflected beam 114 may be referred to as a return beam, received beam, return light, received light, input light, scattered light, or reflected light. As used herein, scattered light may refer to light that is scattered or reflected by a target 120. For instance, a reflected beam 114 may include: light from the emitter beam 118 that is scattered by target 120; light from the emitter beam 118 that is reflected by target 120, or a combination of scattered and reflected light from target 120.

In particular embodiments, the receiver 112a may receive or detect photons from reflected beam 114 and generate one or more representative signals. For example, the receiver 112a may generate an output electrical signal that is representative of the reflected beam 114. This electrical signal may be sent to controller 108. In particular embodiments, controller 108 may include a processor, computing system (e.g., an ASIC or FPGA), or other suitable circuitry configured to analyze one or more characteristics of the electrical signal from the receiver 112a to determine one or more characteristics of the target 120, such as its distance downrange from the LiDAR system 100. This can be done, for example, by analyzing the time of flight or phase modulation for a beam of light 118 transmitted by the light source 102. In one example, if a time of flight is measured to be T=300 ns, then the distance from the target 120 to the LiDAR system 100 may be determined to be approximately D=45.0 m. As another example, if a time of flight is measured to be T=1.33 microseconds, then the distance from the target 120 to the LiDAR system 100 may be determined to be approximately D=199.5 m. In particular embodiments, a distance D from LiDAR system 100 to a target 120 may be referred to as a distance, depth, or range of target 120. As used herein, the speed of light c refers to the speed of light in any suitable medium, such as for example in air, water, or vacuum.

In particular embodiments, light source 102 may include a pulsed laser. As an example, light source 102 may be a pulsed laser that produces pulses of light with a pulse duration or pulse width of approximately 10 picoseconds (ps) to 20 nanoseconds (ns). As another example, light source 102 may be a pulsed laser that produces pulses with a pulse duration of approximately 200-400 ps. As another example, light source 102 may be a pulsed laser that produces pulses at a pulse repetition frequency or a pulse period (e.g., a time between consecutive pulses). In particular embodiments, light source 102 may have a substantially constant pulse repetition frequency, or light source 102 may have a variable or adjustable pulse repetition frequency. In still another example, the light source 102 may be a continuous wave light sent by the emitter 106. For instance, light source 102 may be a pulsed laser that produces pulses at a substantially constant pulse repetition frequency of approximately 640 kHz, corresponding to a pulse period of approximately 1.56 microseconds.

In particular embodiments, light source 102 may produce a free-space emitter beam 118 having any suitable average optical power, and the emitter beam 118 may have optical pulses with any suitable pulse energy or peak optical power. In one example, emitter beam 118 may have an average power of approximately 1 mW, 10 mW, 100 mW, 1 W, 10 W, or any other suitable average power. As another example, emitter beam 118 may include pulses with a pulse energy of approximately 0.1 μJ, 1 μJ, 10 μJ, 100 μJ, 1 μJ, or any other suitable pulse energy. As another example, emitter beam 118 may include pulses with a peak power of approximately 10 W, 100 W, 1 kW, 5 kW, 10 kW, or any other suitable peak power. An optical pulse with a duration of 400 ps and a pulse energy of 1μJ has a peak power of approximately 2.5 kW.

In some instances, light source 102 may include a laser diode, such as a Fabry-Perot laser diode, a quantum well laser, a distributed Bragg reflector (DBR) laser, a distributed feedback (DFB) laser, or a vertical-cavity surface-emitting laser (VCSEL). As an example, light source 102 may include an aluminum-gallium-arsenide (AlGaAs) laser diode, an indium-gallium-arsenide (InGaAs) laser diode, or an indium-gallium-arsenide-phosphide (InGaAsP) laser diode. In particular embodiments, light source 102 may include a pulsed laser diode with a peak emission wavelength of approximately 1400-1600 nm. For instance, light source 102 may include a laser diode that is current modulated to produce optical pulses. In some instances, light source 102 may include a pulsed laser diode followed by one or more optical-amplification stages. In one example, light source 102 may be a fiber-laser module that includes a current-modulated laser diode with a peak wavelength of approximately 1550 nm followed by a single-stage or a multi-stage erbium-doped fiber amplifier (EDFA). As another example, light source 102 may include a continuous-wave (CW) or quasi-CW laser diode followed by an external optical modulator (e.g., an electro-optic modulator), and the output of the modulator may be fed into an optical amplifier.

In some instances, an emitter beam 118 emitted by light source 102 may be a collimated optical beam with any suitable beam divergence, such as for example, a divergence of approximately 0.1 to 3.0 milliradian (mrad). A divergence of emitter beam 118 may refer to an angular measure of an increase in beam size (e.g., a beam radius or beam diameter) as emitter beam 118 travels away from light source 102 or LiDAR system 100. In some instances, emitter beam 118 may have a substantially circular cross section with a beam divergence characterized by a single divergence value.

An emitter beam 118 with a circular cross section and a divergence of 1 mrad may have a beam diameter or spot size of approximately 10 cm at a distance of 100 m from LiDAR system 100. In another example, emitter beam 118 may be an astigmatic beam or may have a substantially elliptical cross section and may be characterized by two divergence values. As an example, emitter beam 118 may have a fast axis and a slow axis, where the fast-axis divergence is greater than the slow-axis divergence. As another example, output beam 118 may be an astigmatic beam with a fast-axis divergence of 2 mrad and a slow-axis divergence of 0.5 mrad.

In some instances, an emitter beam 118 emitted by light source 102 may be unpolarized or randomly polarized, may have no specific or fixed polarization (e.g., the polarization may vary with time), or may have a particular polarization (e.g., output beam 118 may be linearly polarized, elliptically polarized, or circularly polarized). In one example, light source 102 may produce linearly polarized light, and LiDAR system 100 may include a quarter-wave plate that converts this linearly polarized light into circularly polarized light. The circularly polarized light may be transmitted as emitter beam 118, and LiDAR system 100 may receive reflected beam 114, which may be substantially or at least partially circularly polarized in the same manner as the emitter beam 118 (e.g., if emitter beam 118 is right-hand circularly polarized, then reflected beam 114 may also be right-hand circularly polarized).

The reflected beam 114 may pass through the same quarter-wave plate (or a different quarter-wave plate) resulting in the reflected beam 114 being converted to linearly polarized light which is orthogonally polarized (e.g., polarized at a right angle) with respect to the linearly polarized light produced by light source 102. As another example, LiDAR system 100 may employ polarization-diversity detection where two polarization components are detected separately. The emitter beam 118 may be linearly polarized, and the LiDAR system 100 may split the reflected beam 114 into two polarization components (e.g., s-polarization and p-polarization) that are detected separately by two photodiodes (e.g., a balanced photoreceiver that includes two photodiodes).

In particular embodiments, LiDAR system 100 may include one or more optical components configured to condition, shape, filter, modify, steer, or direct the emitter beam 118 or the reflected beam 114. As an example, LiDAR system 100 may include one or more lenses, mirrors, filters (e.g., bandpass or interference filters), beam splitters, polarizers, polarizing beam splitters, wave plates (e.g., half-wave or quarter-wave plates), diffractive elements, or holographic elements. In some instances, LiDAR system 100 may include a telescope, one or more lenses, or one or more mirrors to expand, focus, or collimate the emitter beam 118 to a desired beam diameter or divergence. For instance, the LiDAR system 100 may include one or more lenses to focus the reflected beam 114 onto an active region of receiver 112a. As another example, the LiDAR system 100 may include one or more flat mirrors or curved mirrors (e.g., concave, convex, or parabolic mirrors) to steer or focus the emitter beam 118 or the reflected beam 114. For example, the LiDAR system 100 may include an off-axis parabolic mirror to focus the reflected beam 114 onto an active region of receiver 112a.

As illustrated in FIG. 1, the LiDAR system 100 may include the mirror 104 (e.g., metallic or dielectric mirror. In particular embodiments, the mirror 104 may provide for emitter beam 118 and reflected beam 114 to be substantially coaxial so that the two beams travel along substantially the same optical path (albeit in opposite directions).

In some instances, LiDAR system 100 may include the emitter 106 to steer the emitter beam 118 in one or more directions downrange. As an example, the emitter 106 may include one or more scanning mirrors that are configured to rotate, tilt, pivot, or move in an angular manner about one or more axes. In particular embodiments, a flat scanning mirror may be attached to a scanner actuator or mechanism which scans the mirror over a particular angular range. In one example, the emitter 106 may include a galvanometer scanner, a resonant scanner, a piezoelectric actuator, a polygonal scanner, a rotating-prism scanner, a voice coil motor, a DC motor, a stepper motor, or a microelectromechanical systems (MEMS) device, or any other suitable actuator or mechanism.

In some instances, the emitter 106 may be configured to scan the emitter beam 118 over a 5-degree angular range, 20-degree angular range, 30-degree angular range, 60-degree angular range, or any other suitable angular range. As an example, a scanning mirror may be configured to periodically rotate over a 15-degree range, which results in the emitter beam 118 scanning across a 30-degree range (e.g., a 0-degree rotation by a scanning mirror results in a 20-degree angular scan of emitter beam 118). In some instances, a field of regard (FOR) of a LiDAR system 100 may refer to an area or angular range over which the LiDAR system 100 may be configured to scan or capture distance information. As an example, a LiDAR system 100 with an emitter beam 118 with a 30-degree scanning range may be referred to as having a 30-degree angular field of regard. As another example, a LiDAR system 100 with a scanning mirror that rotates over a 30-degree range may produce an emitter beam 118 that scans across a 60-degree range (e.g., a 60-degree FOR). In particular embodiments, LiDAR system 100 may have a FOR of approximately 10 degrees, 20 degrees, 40 degrees, 60 degrees, 120 degrees, or any other suitable FOR.

In some instances, emitter 106 may be configured to scan the emitter beam 118 horizontally and vertically, and LiDAR system 100 may have a particular FOR along the horizontal direction and another particular FOR along the vertical direction. In one example, LiDAR system 100 may have a horizontal FOR of 10 degrees to 120 degrees and a vertical FOR of 2 degrees to 45 degrees. In particular embodiments, emitter 106 may include a first mirror and a second mirror, where the first mirror directs the emitter beam 118 toward the second mirror, and the second mirror directs the emitter beam 118 downrange. In one example, the first mirror may scan the emitter beam 118 along a first direction, and the second mirror may scan the emitter beam 118 along a second direction that is substantially orthogonal to the first direction. As another example, the first mirror may scan the emitter beam 118 along a substantially horizontal direction, and the second mirror may scan the emitter beam 118 along a substantially vertical direction (or vice versa). In some instances, emitter 106 may be referred to as a beam scanner, optical scanner, or laser scanner.

In particular embodiments, one or more scanning mirrors may be communicatively coupled to controller 108 which controls the scanning mirror(s) so as to guide the emitter beam 118 in a desired direction downrange or along a desired scan pattern. In some instances, a scan pattern (which may be referred to as an optical scan pattern, optical scan path, or scan path) may refer to a pattern or path along which the emitter beam 118 is directed.

In some instances, the receiver 112a may be referred to as a photoreceiver, optical receiver, optical sensor, detector, photodetector, or optical detector. In particular embodiments, LiDAR system 100 may include the receiver 112a that receives or detects at least a portion of reflected beam 114 and produces an electrical signal that corresponds to reflected beam 114. In one example, if the reflected beam 114 includes an optical pulse, then the receiver 112a may produce an electrical current or voltage pulse that corresponds to the optical pulse detected by the receiver 112a. As another example, the receiver 112a may include one or more avalanche photodiodes (APDs) or one or more single-photon avalanche diodes (SPADs). As another example, the receiver 112a may include one or more PN photodiodes (e.g., a photodiode structure formed by a p-type semiconductor and a n-type semiconductor) or one or more PIN photodiodes (e.g., a photodiode structure formed by an undoped intrinsic semiconductor region located between p-type and n-type regions).

The receiver 112a may have an active region or an avalanche-multiplication region that includes silicon, germanium, or InGaAs. The active region of receiver 112a may have any suitable size, such as for example, a diameter or width of approximately 50-500 micrometers. In some instances, receiver 112a may include circuitry that performs signal amplification, sampling, filtering, signal conditioning, analog-to-digital conversion, time-to-digital conversion, pulse detection, threshold detection, rising-edge detection, or falling-edge detection. In one example, the receiver 112a may include a transimpedance amplifier that converts a received photocurrent (e.g., a current produced by an APD in response to a received optical signal) into a voltage signal. The voltage signal may be sent to pulse-detection circuitry that produces an analog or digital output signal that corresponds to one or more characteristics (e.g., rising edge, falling edge, amplitude, or duration) of a received optical pulse. For instance, the pulse-detection circuitry may perform a time-to-digital conversion to produce a digital output signal. The electrical output signal may be sent to the controller 108 for processing or analysis (e.g., to determine a time-of-flight value corresponding to a received optical pulse).

In particular embodiments, the controller 108 may be electrically coupled or communicatively coupled to the light source 102, the emitter 106, or the receiver 112a. In one example, the controller 108 may receive electrical trigger pulses or edges from the light source 102, where each pulse or edge corresponds to the emission of an optical pulse by the light source 102. As another example, the controller 108 may provide instructions, a control signal, or a trigger signal to the light source 102 indicating when the light source 102 should produce optical pulses. The controller 108 may send an electrical trigger signal that includes electrical pulses, where each electrical pulse results in the emission of an optical pulse by the light source 102. In some instances, the frequency, period, duration, pulse energy, peak power, average power, or wavelength of the optical pulses produced by the light source 102 may be adjusted based on instructions, a control signal, or trigger pulses provided by the controller 108. In some instances, the controller 108 may be coupled to the light source 102 and the receiver 112a, and the controller 108 may determine a time-of-flight value for an optical pulse based on timing information associated with when the pulse was emitted by the light source 102 and when a portion of the pulse (e.g., reflected beam 114) was detected or received by receiver 112a. In particular embodiments, the controller 108 may include circuitry that performs signal amplification, sampling, filtering, signal conditioning, analog-to-digital conversion, time-to-digital conversion, pulse detection, threshold detection, rising-edge detection, or falling-edge detection.

In some instances, a LiDAR system 100 may be used to determine the distance to one or more downrange targets 120. By scanning the LiDAR system 100 across a FOR, the system can be used to map the distance to a number of points within the field of regard. Each of these depth-mapped points may be referred to as a pixel. A collection of pixels captured in succession (which may be referred to as a depth map, a point cloud, or a frame) may be rendered as an image or may be analyzed to identify or detect objects or to determine a shape or distance of objects within the FOR. In one example, a depth map may cover a FOR that extends 60 degrees horizontally and 15 degrees vertically, and the depth map may include a frame of 100-2000 pixels in the horizontal direction by 4-400 pixels in the vertical direction.

In particular embodiments, the LiDAR system 100 may be configured to repeatedly capture or generate point clouds of a field of regard at any suitable frame rate between approximately 0.1 frames per second (FPS) and approximately 1,000 FPS. In one example, LiDAR system 100 may be configured to produce optical pulses (e.g., the system may determine 500,000 pixel distances per second) and scan a frame of 1000 times 50 pixels (e.g., 50,000 pixels/frame), which corresponds to a point-cloud frame rate of 10 frames per second (e.g., 10 point clouds per second). In some instances, a point-cloud frame rate may be substantially fixed, or a point-cloud frame rate may be dynamically adjustable. In one example, the LiDAR system 100 may capture one or more point clouds at a particular frame rate (e.g., 1 Hz) and then switch to capture one or more point clouds at a different frame rate (e.g., 10 Hz). A slower frame rate (e.g., 1 Hz) may be used to capture one or more high-resolution point clouds, and a faster frame rate (e.g., 10 Hz) may be used to rapidly capture multiple lower-resolution point clouds.

In some instances, the LiDAR system 100 may be configured to sense, identify, or determine distances to one or more targets 120 within a field of regard. In one example, a LiDAR system 100 may determine a distance to a target 120, where all or part of the target 120 is contained within a field of regard of the LiDAR system 100. In particular embodiments, the target 120 may include all or part of an object that is moving or stationary relative to the LiDAR system 100. As an example, the target 120 may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects.

In particular embodiments, one or more LiDAR systems 100 may be integrated into a vehicle. In one example, multiple LiDAR systems 100 may be integrated into a car to provide a complete 360-degree horizontal FOR around the car. As another example, 6-10 LiDAR systems 100, each system having a 45-degree to 90-degree horizontal FOR, may be combined together to form a sensing system that provides a point cloud covering a 360-degree horizontal FOR. The LiDAR systems 100 may be oriented so that adjacent FORs have an amount of spatial or angular overlap to allow data from the multiple LiDAR systems 100 to be combined or stitched together to form a single or continuous 360-degree point cloud. In one example, the FOR of each LiDAR system 100 may have approximately 1-15 degrees of overlap with an adjacent FOR. In particular embodiments, a vehicle may refer to a mobile machine configured to transport people or cargo. For example, a vehicle may include, may take the form of, or may be referred to as a car, automobile, motor vehicle, truck, bus, van, trailer, off-road vehicle, farm vehicle, lawn mower, construction equipment, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), or spacecraft. In some instances, a vehicle may include an internal combustion engine or an electric motor that provides propulsion for the vehicle.

In particular embodiments, one or more LiDAR systems 100 may be included in a vehicle as part of an advanced driver assistance system (ADAS) to assist a driver of the vehicle in the driving process. For example, a LiDAR system 100 may be part of an ADAS that provides information or feedback to a driver (e.g., to alert the driver to potential problems or hazards) or that automatically takes control of part of a vehicle (e.g., a braking system or a steering system) to avoid collisions or accidents. A LiDAR system 100 may be part of a vehicle ADAS that provides adaptive cruise control, automated braking, automated parking, collision avoidance, alerts the driver to hazards or other vehicles, maintains the vehicle in the correct lane, or provides a warning if an object or another vehicle is in a blind spot.

In some instances, one or more LiDAR systems 100 may be integrated into a vehicle as part of an autonomous-vehicle driving system. In one example, a LiDAR system 100 may provide information about the surrounding environment to a driving system of an autonomous vehicle. An autonomous-vehicle driving system may include one or more computing systems that receive information from a LiDAR system 100 about the surrounding environment, analyze the received information, and provide control signals to the vehicle's driving systems (e.g., steering wheel, accelerator, brake, or turn signal). In one example, a LiDAR system 100 integrated into an autonomous vehicle may provide an autonomous-vehicle driving system with a point cloud every 0.1 seconds (e.g., the point cloud has a 10 Hz update rate, representing 10 frames per second).

Continuing with the above driving example, the autonomous-vehicle driving system may analyze the received point clouds to sense or identify targets 120 and their respective distances or speeds, and the autonomous-vehicle driving system may update control signals based on this information. For instance, if the LiDAR system 100 detects a vehicle ahead that is slowing down or stopping, the autonomous-vehicle driving system may send instructions to release the accelerator and apply the brakes.

In some instances, an autonomous vehicle may be referred to as an autonomous car, driverless car, self-driving car, robotic car, or unmanned vehicle. In particular embodiments, an autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

In some instances, an autonomous vehicle may be configured to drive with a driver present in the vehicle, or an autonomous vehicle may be configured to operate the vehicle with no driver present. As an example, an autonomous vehicle may include a driver's seat with associated controls (e.g., steering wheel, accelerator pedal, and brake pedal), and the vehicle may be configured to drive with no one seated in the driver's seat or with little or no input from a person seated in the driver's seat. As another example, an autonomous vehicle may not include any driver's seat or associated driver's controls, and the vehicle may perform substantially all driving functions (e.g., driving, steering, braking, parking, and navigating) without human input. As another example, an autonomous vehicle may be configured to operate without a driver (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

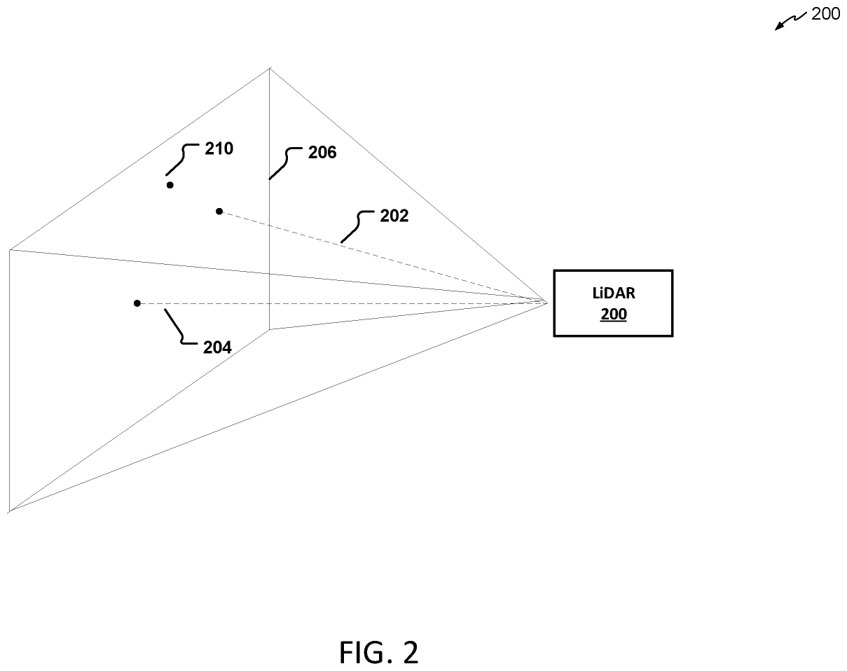

FIG. 2 illustrates an example scan pattern 206 produced by a LiDAR system 200. In particular embodiments, the LiDAR system 200 may be configured to scan output optical beam 118 along one or more particular scan patterns. In some instances, the scan pattern 206 may have any suitable horizontal FOR and any suitable vertical FOR. In the example of FIG. 2, reference line 204 represents a center of the field of regard of the scan pattern 206. In particular embodiments, the reference line 204 may have any suitable orientation, such as for example, a horizontal angle of 0 degrees (e.g., the reference line 204 may be oriented straight ahead) and a vertical angle of 0 degrees (e.g., the reference line 204 may have an inclination of 0 degrees), or the reference line 204 may have a nonzero horizontal angle or a nonzero inclination (e.g., a vertical angle of +10 degrees or −10 degrees). In some instances, an azimuth (which may be referred to as an azimuth angle) may represent a horizontal angle with respect to the reference line 204, and an altitude (which may be referred to as an altitude angle, elevation, or elevation angle) may represent a vertical angle with respect to the reference line 204.

In some instances, the scan pattern 206 may include multiple pixels and each pixel 208 may be associated with one or more laser pulses and one or more corresponding distance measurements. In particular embodiments, a cycle of the scan pattern 206 may include a total of Px times Py pixels 208 (e.g., a two-dimensional distribution of Px by Py pixels). For instance, scan pattern 206 may include a distribution with dimensions of approximately 100-2,000 pixels 208 along a horizontal direction and approximately 4-400 pixels 208 along a vertical direction. As another example, the scan pattern 206 may include a distribution of 1,000 pixels 208 along the horizontal direction by 64 pixels 208 along the vertical direction (e.g., the frame size is 1000 times 64 pixels) for a total of 64,000 pixels per cycle of scan pattern 206. In some instances, the number of pixels 208 along a horizontal direction may be referred to as a horizontal resolution of the scan pattern 206, and the number of pixels 208 along a vertical direction may be referred to as a vertical resolution. In one example, the scan pattern 206 may have a horizontal resolution of greater than or equal to 100 pixels 208 and a vertical resolution of greater than or equal to 4 pixels 208. As another example, scan pattern 206 may have a horizontal resolution of 100-2,000 pixels 208 and a vertical resolution of 4-400 pixels 208.

In some instances, each pixel 208 may be associated with a distance (e.g., a distance to a portion of a target 120 from which an associated laser pulse was scattered) or one or more angular values. For instance, a pixel 208 may be associated with a distance value and two angular values (e.g., an azimuth and altitude) that represent the angular location of the pixel 208 with respect to the LiDAR system 200. A distance to a portion of target 120 may be determined based at least in part on a time-of-flight measurement for a corresponding pulse. An angular value (e.g., an azimuth or altitude) may correspond to an angle (e.g., relative to reference line 204) of emitter beam 118 (e.g., when a corresponding pulse is emitted from LiDAR system 200) or an angle of input beam 202 (e.g., when an input signal is received by LiDAR system 200). In particular embodiments, an angular value may be determined based at least in part on a position of a component of emitter 106. In one example, an azimuth or altitude value associated with a pixel 208 may be determined from an angular position of one or more corresponding scanning mirrors of emitter 106.

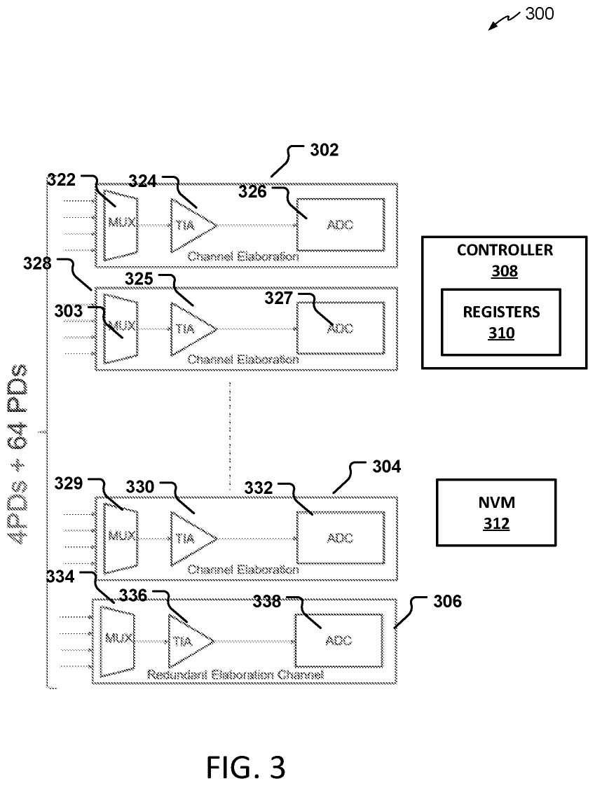

FIG. 3 is block diagram showing a LiDAR system 300 having a plurality of channels 302, 303, 304, 306, implemented in silicon. The channels 302, 303, 304, 306 include at least one redundant channel 306, an MCU 308 with registers 310, as well as a nonvolatile memory (NVM) 312, all or some of which may be used to swap out operation of a failed channel 303 for that of the redundant channel 306. An embodiment of the system 300 may use the channels 302, 303, 304, 306 (i.e., elaboration channels) for redundancy. The registers 310 may be internal to the MCU 308 and may be used to manage the redundancy. A power on/reset flow coordinated by the MCU 308 may enable the redundant resource and disable the defective ones

Storage in an embodiment may occur in volatile form, so that the MCU interfacing with a vehicle bus, for instance, can investigate the healthy status of the channel at each power up. If the store is performed in nonvolatile memory, the external MCU may merely load the data in the LiDAR internal registers 310 to ensure that the acquisition of the faulty channel is replaced by the acquisition of the redundant channel. The nonvolatile storing of the data can happen on a memory connected to the MCU interfacing with the vehicle bus or on the LiDAR device, itself.

Each channel 302, 303, 304, 306 includes a multiplexor (MUX) 322, 328, 334 a trans-impedance amplifier (TIA) 324, 330, 336 and an analog to digital converter (ADC) 326, 332, 338. As shown in the illustrative example of FIG. 3, the system includes 64 photodiode, plus an additional four photodiodes associated with the redundant channel 306. Each channel 302, 303, 304, 306 receives a set 314, 316, 318, 320 of four inputs from four photodiodes. That is, each channel includes four photodiodes to be converted.

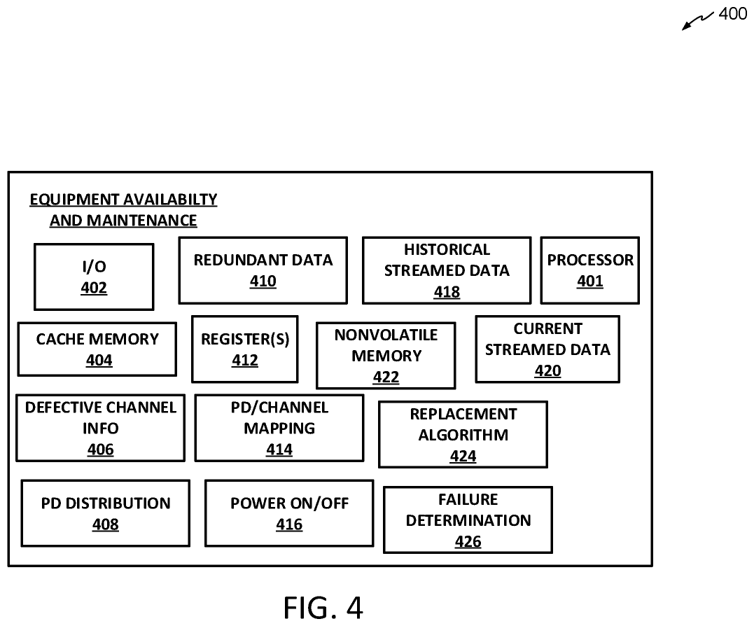

FIG. 4 is a block diagram of a system 400, similar to the MCU 308 of FIG. 3, having software and hardware modules 401, 402, 404, 406, 408, 410, 412, 414, 416, 418, 420, 422, 424, 426 configured to employ redundant, or backup channels. In another embodiment, a controller internal to a channel, such as the controller 108 of FIG. 1, may be alternatively or additionally used.

For example, the system 400 may include and a processor 401, an input/output module 402, as well as a cache memory 404. As explained herein, the system 400 may include one or more registers 412. The registers 412 may be used to store information used by the processor 401 to seamlessly switch operation from a failed channel to a backup, redundant channel. For instance, a register 412 may include a field identifying the failed register and the redundant register.

The processor 401 may populate the registers 412 using defective channel information 406. The system 400 may execute a failure determination algorithm 426. According to one embodiment, the determination may include comparing archived data 418 to currently streamed data 420. The system 400 may additionally include nonvolatile memory 422 and photodiode (PD) to channel mapping information and routing algorithms 414. The inclusion of the illustrative modules 401, 402, 404, 406, 408, 410, 412, 414, 416, 418, 420, 422, 424, 426 are merely for illustrative purposes, and one skilled in the art will appreciate that other such modules may be included and be collectively called, program code.

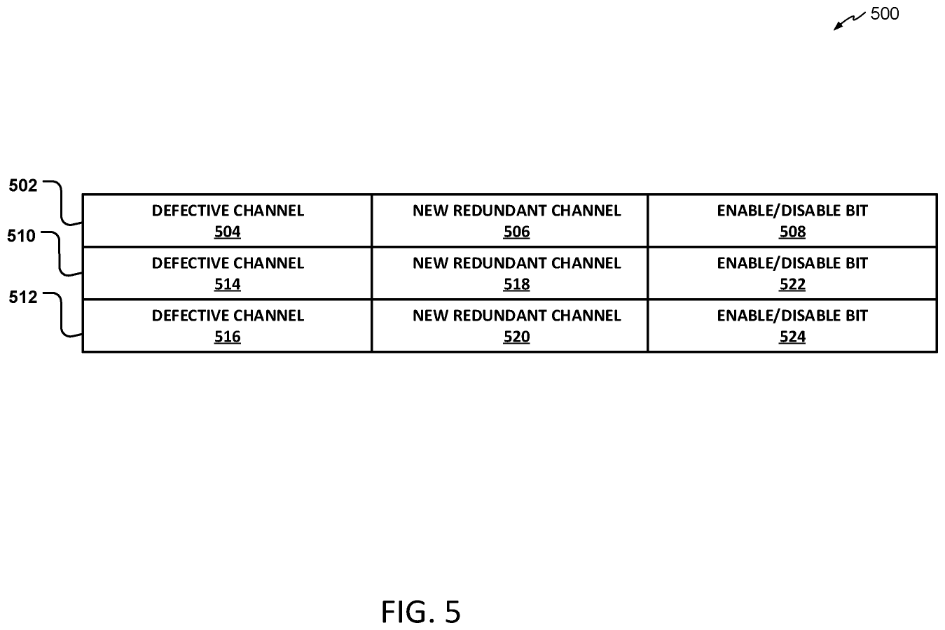

FIG. 5 is a block diagram of a register 500, such as may be included in the plurality of registers 310 shown in FIG. 3, for use in seamlessly switching operation from a failed channel to a redundant channel. A first line 502 of the register 500 includes first field 504 data identifying a defective channel, a second field 506 having data identifying a new, redundant channel, as well as a field 508 having an enabling bit (e.g., for enabling redundancy). Second and third lines 510, 512 of the register 500 each also include first fields 514, 516 corresponding to a respective failed channels, second fields 518, 520 relating to redundant channels, and their fields 522, 524 flagging that the register should be used by the MCU to transition operation of one or more of the failed channels to a redundant channels.

According to a particular embodiment, each register 500 may include read/write properties. The register 500 may also include addresses of a defective channels. Each register 500 may additionally include fields that include addresses of redundant channels. A field of one bit for each register 500 (or redundant resource/channel) may include data to enable or disable the redundant resource.

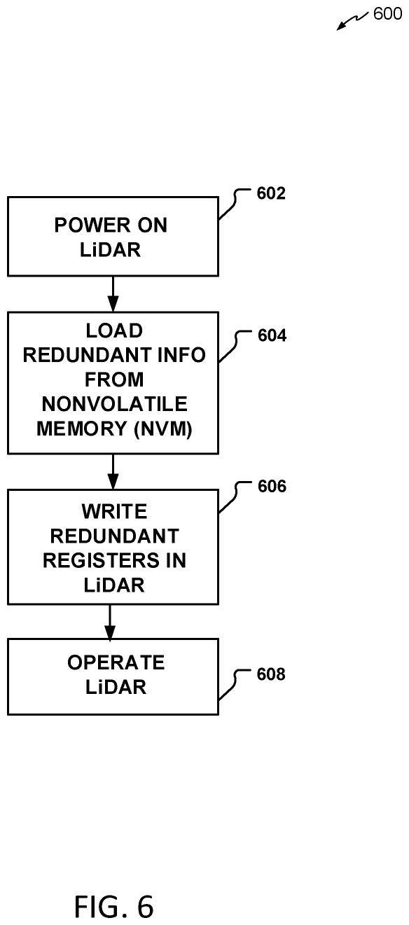

FIG. 6 is a flowchart of an embodiment of a method 600 having illustrative steps for operating a LiDAR using a redundant channel and a nonvolatile memory that stores redundant data. The method 600 may be performed by an MCU, such as the controller 308 of the system 300 of FIG. 3, or the controller 108 of the system 100.

At 602, the system, such as the LiDAR system 300 of FIG. 3, may be powered. An MCU, such as the controller 308 of FIG. 3, may load at 604 the redundant information from nonvolatile memory, such as the nonvolatile memory 312 of FIG. 3. The nonvolatile memory may be external to the MCU.

At 606, the MCU may write the redundant registers in the LiDAR. As such, the updated redundant data and the channel replacement may be initiated after power on. The redundant data may be used to provide continuity by routing streaming data to the redundant channel (e.g., via the photodiode linked to the redundant channel) that would have otherwise have gone to the failed channel. The LiDAR may be ready to operate at 608.

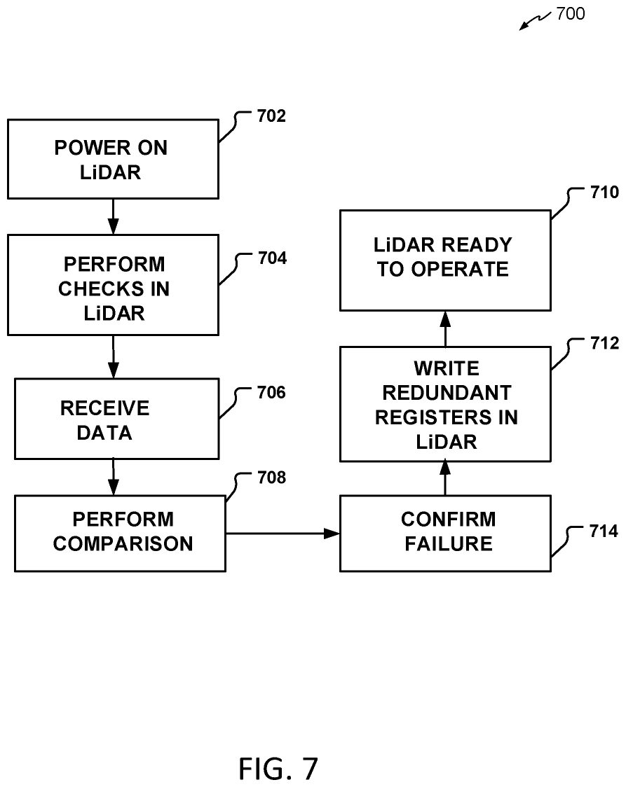

FIG. 7 is a flowchart of an embodiment of a method 700 having illustrative steps for operating a LiDAR using a redundant channel after performing a comparison of streamed data verses archived data. The method 700 may be performed by an MCU, such as the controller 308 of the system 300 of FIG. 3, or the controller 108 of the system 100 of FIG. 1. Turning more particularly to the flowchart, the LiDAR may be powered on at 702. The MCU may initiate checking the operation of the LiDAR at 704.

At 706, the MCU may receive data, and perform a comparison at 708. Should a failure be confirmed at 714 from the comparison, the system may write the redundant registers in the LiDAR.

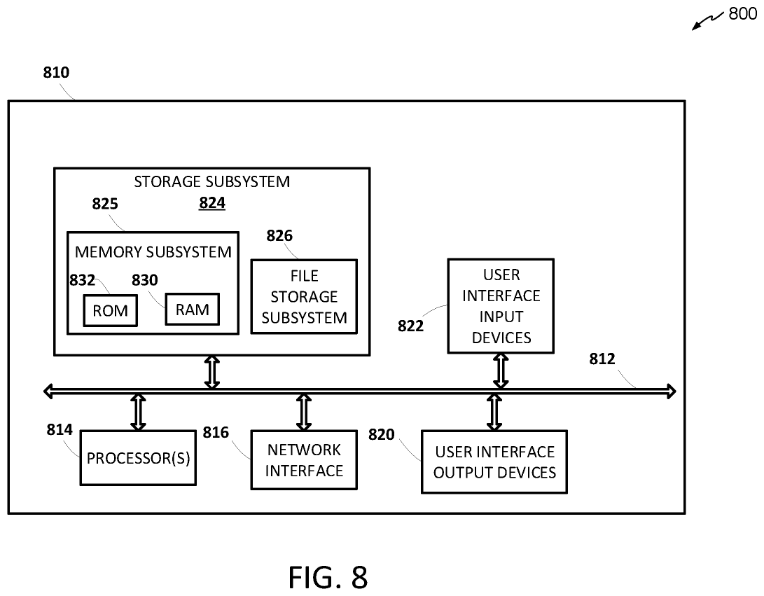

FIG. 8 is a block diagram of an example computing device 810 that may optionally be utilized to perform one or more aspects of techniques described herein. In some implementations, one or more of a client computing device, user-controlled resources engine, and/or other component(s) may comprise one or more components of the example computing device 810.

Computing device 810 typically includes at least one processor 814 that communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The user interface input devices 822 of an implementation may include a response volume setting, among other features. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of the method and to implement various components depicted in FIGS. 1-7.

These software modules are generally executed by processor 814 alone or in combination with other processors. Memory subsystem 825 used in the storage subsystem 824 may include a number of memories including a main random access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem may use multiple busses.

The computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method of operating a light detection and ranging (LiDAR), the method comprising:
detecting a failure in a first channel of a plurality of channels of a LiDAR;
storing redundant data associated with operation of the first channel; and
in response to detecting the failure, switching out the operation of the first channel for operation of a second channel of the plurality of channels using the stored redundant data.

2. The method of claim 1, wherein a third channel is additionally configured to take over the operation of the first channel.

3. The method of claim 1, wherein the stored redundant data includes information to send an input from a first photodiode associated with the first channel to the second channel.

4. The method of claim 1, wherein detecting the failure includes comparing currently streamed data to archived data.

5. The method of claim 1, further comprising updating a redundant register to reflect a failed status of the first channel.

6. The method of claim 1, further comprising updating a redundant register to include redundant data.

7. The method of claim 1, further comprising storing the redundant data within a redundant register.

8. The method of claim 1, further comprising deactivating the operation of the first channel.

9. The method of claim 1, wherein storing the redundant data comprises storing the redundant data in either a nonvolatile or a volatile memory.

10. An apparatus comprising:
a first channel of a plurality of channels of a LiDAR;
a second channel of the plurality of channels;
a memory storing redundant data associated with operation of the first channel; and
a processor configured to:
detect a failure in the first channel; and
in response to detecting the failure, switching out the operation of the first channel for operation of the second channel using the stored redundant data.

11. The apparatus of claim 10, further comprising a register accessible by the processor to manage the switching out of the operation.

12. The apparatus of claim 11, wherein the register is internal to the processor.

13. The apparatus of claim 10, further comprising a register accessible by the processor to store information identifying the first and second channels.

14. The apparatus of claim 10, further comprising a register accessible by the processor, wherein the register includes a bit to enable the switching out of the operation.

15. The apparatus of claim 11, wherein the stored redundant data includes a channel output.

16. The apparatus of claim 11, wherein the processor is configured to compare currently streamed data to archived data to detect the failure.

17. The apparatus of claim 11, wherein the processor is configured to deactivate the operation of the first channel.

18. The apparatus of claim 11, wherein the processor is configured to, in storing the redundant data, store the redundant data in either a nonvolatile and a volatile memory.

19. A non-transitory computer-readable medium comprising instructions that, in response to execution of the instructions by a processor, cause the processor to at least perform:
detecting a failure in a first channel of a plurality of channels of a LiDAR;
storing redundant data associated with operation of the first channel; and
in response to detecting the failure, switching out the operation of the first channel for operation of a second channel of the plurality of channels using the stored redundant data.

20. The non-transitory computer-readable medium of claim 19, wherein the instructions, in response to execution of the instructions by the processor, cause the processor to perform accessing a register to manage the switching out of the operation.
